(19) United States
(12) Patent Application Publication
(10) Pub. No.: US 2012/0013555 A1
(43) Pub. Date: Jan. 19, 2012

(54) TOUCH SCREEN SYSTEM

(75) Inventors: Takami MAEDA, Fukuoka (JP); Takashi KITADA, Fukuoka (JP)

(73) Assignee: PANASONIC CORPORATION, Osaka (JP)

(21) Appl. No.: 13/177,879

(22) Filed: Jul. 7, 2011

(30) Foreign Application Priority Data
Jul. 15, 2010 (JP) 2010-160275

(51) Int. Cl. G06F 3/041

(52) U.S. Cl. 345/173

(57) ABSTRACT

Provided is a touch screen system that includes a transmitter, a plurality of electronic pens, and a controller. The transmitter applies to transmitting electrodes a pen-synchronization pulse signal for synchronizing transmission and reception of a pen identification signal between the electronic pens and a receiver. The electronic pens transmit, to receiving electrodes, a pen identification signal in accordance with detection of the pen-synchronization pulse signal of the transmitting electrodes at the time of a touch operation. The controller determines the electronic pen that has performed a touch operation based on the pen identification signal that is received by the receiver via the receiving electrodes.

### CROSS-REFERENCE TO RELATED APPLICATIONS

The present application claims priority under 35 U.S.C. §119 of Japanese Application No. 2010-160275, filed on Jul. 15, 2010, the disclosure of which is expressly incorporated by reference herein in its entirety.

### BACKGROUND OF THE INVENTION

1. Field of the Invention

The present invention relates to a touch screen system which enables a use to perform a touch operation with a plurality of electronic pens.

2. Description of Related Art

Touch screen systems are widely used in the fields of personal computers and mobile information terminals. In combination with a large screen display apparatus, such a touch screen system can be used as an interactive whiteboard used in a presentation or a lecture for a large audience. A touch screen system as the interactive whiteboard is expected to be used particularly in an educational field, such as a school.

Convenience in using such a large touch screen system is enhanced when the system enables a user to operate the system both with a finger touch and with a plurality of electronic pens having different properties (functions) such as a drawing color.

In order to meet the demands set out above, a conventional technology attempts to detect a position touched by either a finger or an electronic pen with high accuracy. In the technology, an electronic pen is provided with an oscillation circuit. When the electronic pen is used for a touch operation, voltage oscillated from the electronic pen is applied to each of a plurality of electrodes. The touch position is detected based on the voltage output according to a distance between each of the electrodes and the electronic pen. When a touch operation is performed by a finger, a driving signal is applied to one of electrodes. The touch position is detected based on change in a signal output from the other electrode according to a decrease of electrostatic capacitance caused in response to a finger touch. Although the conventional technology can distinguish an electronic pen from a finger by comparing a voltage of an electrode with a reference value, the technology cannot distinguish a plurality of electronic pens from one another. Therefore, it is impossible to simultaneously use a plurality of electronic pens with different properties (functions), such as colors (see Related Art 1).

In another known technology, in order to distinguish a plurality of electronic pens from one another, different frequencies are allocated to the electronic pens and each electronic pen sends a signal of the allocated frequency. When a touch operation is performed with an electronic pen, the signal of the electronic pen is superposed on a driving signal. When the frequency of the signal of the electronic pen superposed on the driving signal is detected, which electronic pen is used for the touch operation is determined (see Related Art 2).

In the conventional technology disclosed in Related Art 2, however, it is necessary to provide same number of frequency detection circuits and filter circuits as the number of frequencies allocated to each electronic pen. Thus, the number of electronic pens that can be used at one time is limited.

[Related Art 1] Japanese Patent Laid-open Publication No. H8-137607

[Related Art 2] Japanese Patent No. 3225716

### SUMMARY OF THE INVENTION

In view of the circumstances above, an objective of the present invention is to provide a touch screen system with no limitation in the number of electronic pens that can be used.

The touch screen system according to the present invention includes: a plurality of electronic pens; a panel main body comprising a touch surface, on which a touch operation is performed with the electronic pens, a plurality of transmitting electrodes extending in parallel to one another, and a plurality of receiving electrodes extending in parallel to one another, the transmitting and receiving electrodes being arranged in a grid pattern, to provide a plurality of electrode intersections between the plurality of transmitting electrodes and the plurality of receiving electrodes; a transmitter that applies a driving signal to the transmitting electrodes; a receiver that receives a response signal output from the receiving electrodes that have responded to the driving signal applied to the transmitting electrodes, and outputs detection data of each electrode intersection; and a controller that detects a touch position based on the detection data output from the receiver. Each of the plurality of electronic pens transmits a pen identification signal including pen identification information to the receiving electrodes at the time of the touch operation. The controller determines an electronic pen that performs the touch operation based on the pen identification signal received by the receiver through the receiving electrodes.

In the present invention, the controller determines an electronic pen based on the pen identification signal. Therefore, there is no limitation in the number of electronic pens that can be used, thereby making it possible to use the necessary number of electronic pens.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an overall configuration diagram illustrating an entire touch screen system according to an embodiment of the present invention;

FIG. 2 is a schematic configuration diagram of a transmitter 6;

FIG. 3 is a schematic configuration diagram of an electronic pen 1;

FIGS. 4A and 4B illustrate states of a touch operation performed by the electronic pen 1;

FIG. 5 is a schematic configuration diagram of a receiver 7;

FIG. 6 is a schematic configuration diagram of a reception signal processor 52;

FIG. 7A illustrates a process of a pen identification to identify the electronic pen;

FIG. 7B illustrates a process of a position detection to detect a touch position;

FIG. 8 illustrates a state of position-detection pulse signals and pen-synchronization pulse signals applied to transmitting electrodes 3, and an operating state of switching elements SW provided to receiving electrodes 4;

FIG. 9 illustrates a state of transmitting a pen identification signal in the electronic pen 1, and a state of comparator output of the receiver 7;

FIGS. 10A and 10B illustrate a process of a pen identification to identify the electronic pen 1, and a state of pen detection data stored in a memory of a controller 8; and

FIGS. 11A and 11B illustrate a process of a position detection to detect a touch position, and a state of position detection data stored in the memory of the controller 8.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Embodiments of the present invention will be described hereinafter with reference to the drawings.

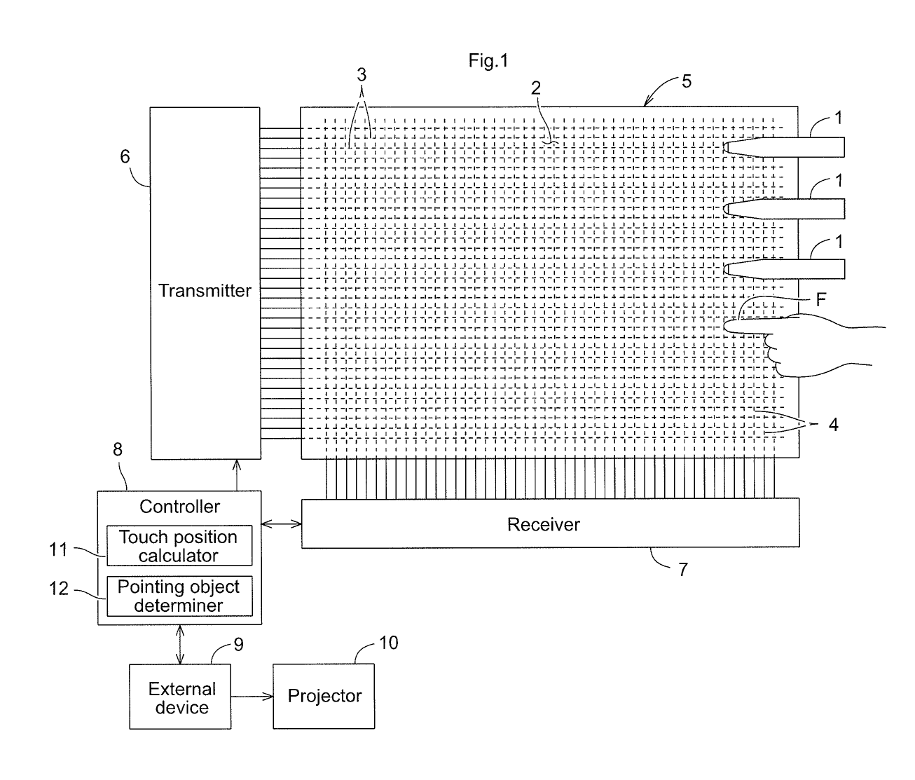

FIG. 1 is a configuration diagram illustrating an entire touch screen system according to an embodiment of the present invention. The touch screen system has a plurality of electronic pens 1, a touch surface 2, a panel main body 5, a transmitter 6, a receiver 7, and a controller 8. On the touch surface 2, touch operations with the electronic pens 1 and a finger F are performed. The panel main body 5 includes a plurality of transmitting electrodes 3 extending in parallel to one another and a plurality of receiving electrodes 4 extending in parallel to one another, the transmitting electrodes 3 and the receiving electrodes 4 being arranged in a grid pattern. The transmitter 6 applies a driving signal (position-detection pulse signal) to the transmitting electrodes 3. The receiver 7 receives a response signal (charge-discharge current signal) from the receiving electrodes 4 that have responded to the driving signal applied to the transmitting electrodes 3, and outputs detection data (level signal) of each electrode intersection, at which the transmitting electrode 3 intersects with the receiving electrode 4. The controller 8 detects a touch position based on the detection data output from the receiver 7, and controls operations of the transmitter 6 and the receiver 7.

Combined with a large-screen display apparatus, the touch screen system is used as an interactive whiteboard used in a presentation or a lecture. In particular, in this embodiment, the touch screen system is used in combination with a projector 10, and the touch surface 2 provided to the panel main body 5 acts as a screen that displays a projection screen of the projector 10.

Touch position information output from the controller 8 is input to an external device 9, such as a personal computer and the like. The external device 9 generates and outputs display screen data to the projector 10. Accordingly, an image is displayed on the touch surface 2 corresponding to a touch operation performed by a user with a pointing object (user's fingertip or a conductor, such as a stylus or a pointer) on the touch surface 2 of the panel main body 5. A desired image can be displayed in a manner similar to when an image is directly drawn on the touch surface 2 with a marker. Further, a button displayed on the display screen can be operated. In addition, an eraser can be used to erase an image drawn in a touch operation.

The transmitting electrodes 3 and the receiving electrodes 4 are provided at a same arrangement or spacing pitch (e.g., 10 mm). The number of electrodes is different depending on an aspect ratio of the panel main body 5. For instance, 120 transmitting electrodes 3 and 186 receiving electrodes 4 may be provided.

The transmitting electrodes 3 and the receiving electrodes 4 intersect in a stacked state with an insulating layer in between. A capacitor is formed at an electrode intersection, at which the transmitting electrode 3 intersects with the receiving electrode 4. When a pointing object, such as a finger, approaches or contacts the touch surface 2 through user's touch operation with the pointing object, capacitance at the electrode intersection is substantially reduced, thereby making it possible to detect whether or not a touch operation is performed.

In this embodiment, a mutual capacitance type is employed. When a driving signal is applied to the transmitting electrodes 3, a charge-discharge current flows in the receiving electrodes 4 in response. Then, the charge-discharge current is output from the receiving electrodes 4 as a response signal. At this moment, when capacitance at the electrode intersection changes in response to a user's touch operation, the charge-discharge current in the receiving electrodes 4, namely the response signal, also changes. The touch position is calculated based on an amount of change in the charge-discharge current. In this mutual capacitance type, detection data obtained by the receiver 7 through signal processing of the response signal is output for each of the electrode intersections of the transmitting electrodes 3 and the receiving electrodes 4. Thereby, it is possible to perform multi-touch (or multi-point detection), in which a plurality of touch positions are simultaneously detected.

A touch position calculator 11 of the controller 8 obtains a touch position (central coordinate of a touch area) from the detection data of each electrode intersection output from the receiver 7, using a predetermined calculation process. In the calculation of a touch position, a touch position is obtained from the detection data of each of a plurality of electrode intersections (e.g., 4×4), which are adjacent to each other in the X direction (arrangement direction of the receiving electrodes 4) and in the Y direction (arrangement direction of the transmitting electrodes 3), by using a predetermined interpolating method (e.g., centroid method). Thereby, a touch position can be detected at a higher resolution (e.g., equal to or less than 1 mm) than the arrangement pitch (10 mm) of the transmitting electrodes 3 and the receiving electrodes 4.

The touch position calculator 11 of the controller 8 performs a process to obtain the touch position every frame period, in which reception of the detection data ends at each of the electrode intersections throughout the touch surface 2, and outputs touch position information to the external device 9 per frame unit. The external device 9 generates display screen data that connects the touch positions in time-series based on the touch position information of a plurality of temporally successive frames, and outputs the data to the projector 10. In the case of multi-touch, the touch position information including touch positions by a plurality of pointing objects is output per frame unit.

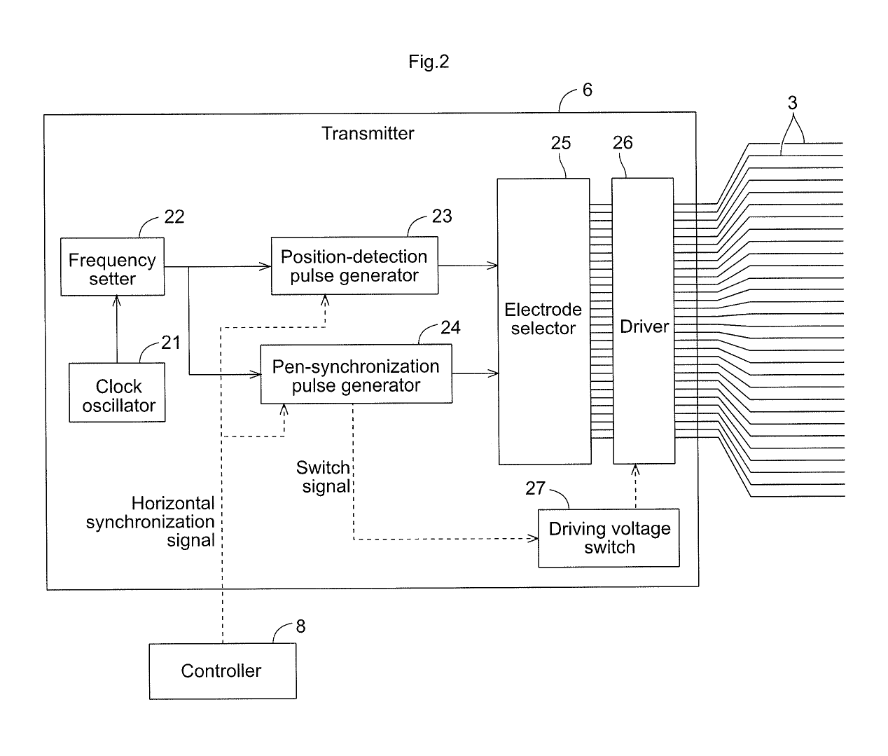

FIG. 2 is a schematic configuration diagram of the transmitter 6. The transmitter 6 includes a clock oscillator 21, a frequency setter 22, a position-detection pulse generator 23, a pen-synchronization pulse generator 24, an electrode selector 25, a driver 26, and a driving voltage switch 27.

The clock oscillator 21 generates a reference clock. The frequency setter 22 sets a frequency of a position-detection pulse signal (driving signal) based on the reference clock generated in the clock oscillator 21, the position-detection pulse signal being applied to the transmitting electrodes 3 in order to detect a position. The position-detection pulse generator 23 generates a pulse train that becomes the position-detection pulse signal (driving signal) at a predetermined frequency based on a value set by the frequency setter 22. The pen-synchronization pulse generator 24 generates a pulse train that becomes a pen-synchronization pulse signal (pen synchronization signal) that synchronizes a transmission and a reception of a pen identification signal between the electronic pens 1 and the receiver 7. The electrode selector 25 selects the transmitting electrodes 3, to which the pulse trains output from the position-detection pulse generator 23 and the pen-synchronization pulse generator 24 are output. The driver 26 outputs the position-detection pulse signal and the pen-synchronization pulse signal at a predetermined voltage.

The position-detection pulse generator 23 and the pen-synchronization pulse generator 24 output pulse trains at a predetermined timing based on a horizontal synchronizing signal output from the controller 8. The electrode selector 25 selects the transmitting electrodes 3 also at a predetermined timing based on the horizontal synchronizing signal.

The electrode selector 25 is provided with a switching element for each transmitting electrode 3. When the switching elements are sequentially turned on, the transmitting electrodes 3 are selected one by one. In the driver 26, the pulses generated by the position-detection pulse generator 23 and the pen-synchronization pulse generator 24 are each converted into the position-detection pulse signal and the pen-synchronization pulse signal having a predetermined voltage level, and then sequentially applied to the transmitting electrodes 3.

The position-detection pulse signal and the pen-synchronization pulse signal are applied to the transmitting electrodes 3 through time sharing. Specifically, in a period of a position detection process that detects a touch position, the pulse generated in the position-detection pulse generator 23 is converted in the driver 26 into a position-detection pulse signal having a predetermined voltage level, and then applied to the transmitting electrodes 3. In a period of a pen identification process that identifies the electronic pens 1, the pulse generated in the pen-synchronization pulse generator 24 is converted in the driver 26 into a pen-synchronization pulse signal having a predetermined voltage level, and then applied to the transmitting electrodes 3.

The driving voltage switch 27 switches an output voltage of the pulse signal in the driver 26 based on a switch signal output from the pen-synchronization pulse generator 24. Here, the position-detection pulse signal and the pen-synchronization pulse signal are applied to the transmitting electrodes 3 at different voltage levels. For example, the position-detection pulse signal may be output at 5 V, and the pen-synchronization pulse signal may be output at 15 V. With high output voltage level of the pen-synchronization pulse signal being applied to the transmitting electrodes 3, it is ensured that the electronic pens 1 receive the pen-synchronization pulse signal without fail. On the other hand, with low output voltage level of the position-detection pulse signal, it is possible to inhibit unnecessary radiation noise.

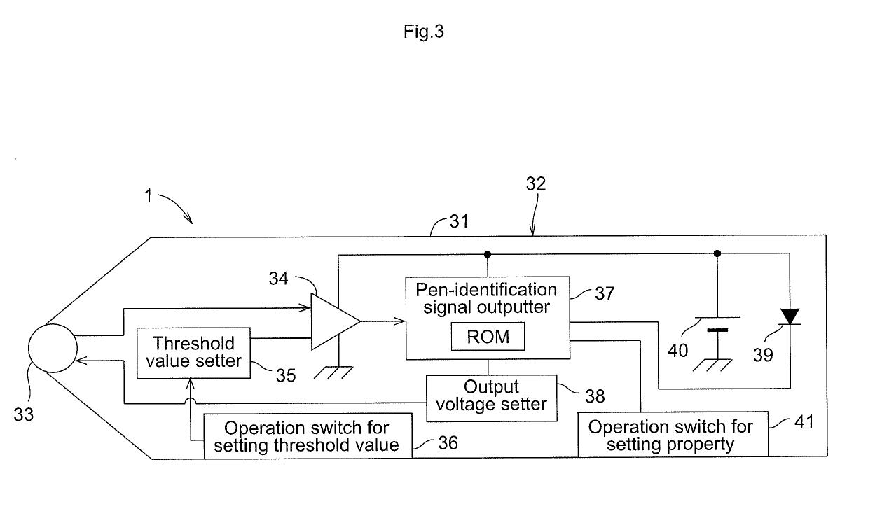

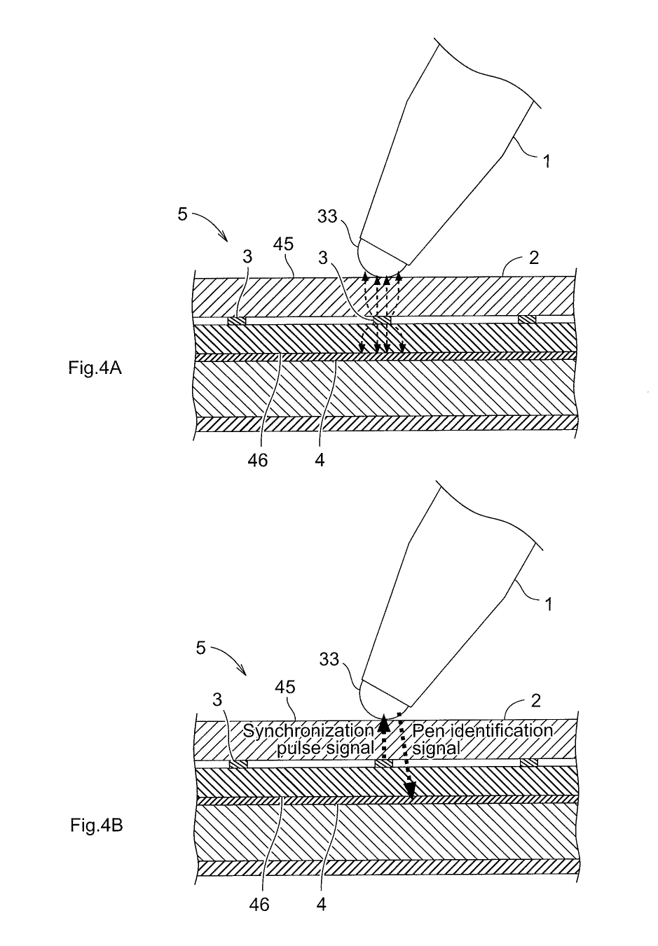

FIG. 3 is a schematic configuration diagram of the electronic pen 1. FIG. 4A and 4B illustrate states of touch operations with the electronic pen 1. FIG. 4A illustrates a state where a touch position is detected, and FIG. 4B illustrates states of receiving a pen-synchronization pulse signal and transmitting a pen identification signal.

As shown in FIG. 3, the electronic pen 1 includes a pen main body 32 having a grip 31, and a pen point 33. The grip 31 is held in the hand of a user. The pen point 33 is pushed against the touch surface 2 of the panel main body 5 when a touch operation is performed. The pen point 33 and the grip 31 of the pen main body 32 are conductive and are electrically connected to each other. Thus, when a user holds the electronic pen 1, the pen point 33 is conducted to a human body through the grip 31.

As shown in FIGS. 4A and 4B, the transmitting electrodes 3 and the receiving electrodes 4 are protected on the front surface side by a protective insulator 45 having the touch surface 2. The transmitting electrodes 3 and the receiving electrodes 4 are supported by a supporter 46. The transmitting electrodes 3 are provided on the front side of the supporter 46; and the receiving electrodes 4 are provided on the back side of the supporter 46. The protective insulator 45 is made of a synthetic resin or the like (e.g., merman resin) having a high electric conductivity to increase sensitivity in detecting a touch operation with a pointing object, such as the electronic pen 1. The supporter 46 acts as an insulating layer provided between the transmitting electrodes 3 and the receiving electrodes 4 to insulate the electrodes. The supporter 46 is composed of a glass plate or a film of synthetic resin (e.g., PET or the like).

As shown in FIG. 4A, when a user performs a touch operation with the electronic pen 1, a static coupling occurs between the electronic pen 1 and the transmitting electrodes 3, and thus capacitance between the transmitting electrodes 3 and the receiving electrodes 4 decreases as a whole. When a position-detection pulse signal is applied to the transmitting electrodes 3, a charge-discharge current generated in the receiving electrodes 4 in response to the signal changes according to the amount of change in the capacitance caused by the touch operation. Thereby, it is possible to detect whether or not there is a touch operation based on the change in the charge-discharge current. Also, the capacitance changes in a same manner when a touch operation is performed with a finger.

As shown in FIG. 3, the electronic pen 1 further includes a comparator (pen-synchronization signal detector) 34, a threshold value setter 35, an operation switch (operator) 36, a pen-identification signal outputter 37, an output voltage adjuster 38, an LED lamp (displaying portion) 39, and a battery 40.

The comparator 34 determines whether or not a signal input from the pen point 33 is a pen-synchronization pulse signal. The threshold value setter 35 sets a threshold value which is used as a reference value when the comparator 34 determines the pen-synchronization pulse signal. The operation switch 36 is used by a user or the like to change the threshold value of the threshold value setter 35. The pen-identification signal outputter 37 outputs a pen identification signal based on an own pen identification information stored in a ROM. The output voltage adjuster 38 adjusts an output voltage level of a pen identification signal. The LED lamp 39 displays an indication that the comparator 34 has detected a pen-synchronization pulse signal.

The pen point 33 of the electronic pen 1 acts as an antenna that sends/receives a signal to/from the transmitting electrodes 3 and the receiving electrodes 4 of the panel main body 5, and receives a pen-synchronization pulse signal of the transmitting electrodes 3 through the protective insulator 45 as shown in FIG. 4B. The pen identification signal output from the pen-identification signal outputter 37 is transmitted from the pen point 33, and is received by the receiving electrodes 4 through the protective insulator 45 and the supporter 46. Because signals are input or output to/from the transmitting electrodes 3 and the receiving electrodes 4 through the protective insulator 45 and the supporter 46, inputting and outputting signals to/from the transmitting electrodes 3 and the receiving electrodes 4 become possible only when the pen point 33 of the electronic pen 1 contacts or sufficiently closely approaches the touch surface 2.

The comparator 34, shown in FIG. 3, compares a reception voltage level of a signal input from the pen point 33 with a threshold value input from the threshold value setter 35, and determines whether or not the signal is a pen-synchronization pulse signal. When the reception voltage level exceeds the threshold value, the comparator 34 outputs a signal to the pen identification outputter 37 to indicate a pen-synchronization pulse signal is detected. It is possible to change the threshold value stored in the threshold value setter 35 using the operation switch 36. The operation switch 36 is operated to adjust the threshold value such that the electronic pen 1 properly receives a pen-synchronization pulse signal. Accordingly, the threshold value, which is a reference value to determine whether or not a received signal is a pen-synchronization pulse signal, can be properly set, thereby making it possible to detect a pen-synchronization pulse signal without fail.

Further, the electronic pen 1 transmits a pen identification signal only after detecting a pen-synchronization pulse signal. With proper detection sensitivity, the electronic pen 1 detects the pen-synchronization pulse signal only when the electronic pen 1 touches or sufficiently closely approaches the touch surface 2, thereby making it possible to transmit a pen identification signal at substantially the same time as a touch operation. In this configuration, the controller 8 receives the pen identification signal from the electronic pen 1 with a smaller time lag than when a mechanical switch is used to detect a touch operation in order to transmit a pen-synchronization signal only when a touch operation is performed. Thereby, it is possible to prevent the controller 8 from mistakenly recognizing the electronic pen 1 as a finger. In addition, the comparator 34 detects a touch operation and eliminates the necessity of another component to detect a touch operation, thereby making it possible to reduce a production cost.

The adjustment of the threshold value by the operation switch 36 is performed while conducting a touch operation with the electronic pen 1 at a predetermined position of the touch surface 2. The reception level of the pen-synchronization pulse signal in the electronic pen 1 varies depending on positions touched by the electronic pen 1. This is because impedance varies according to the length of the transmitting electrodes 3, through which a signal passes after being applied from the transmitter 6 and before being received by the electronic pens 1. In particular, when the touch screen system is used as an interactive whiteboard, the variation of reception level according to the touch positions of the electronic pens 1 becomes more prominent or significant as the system becomes larger in size.

To address the above circumstance, the threshold value is optimized through a threshold value adjustment, in which a touch operation is performed with the electronic pen 1 at a plurality of locations on the touch surface 2, for example, the location closest to the transmitter 6 (e.g., lower left point of the touch surface 2) and the location farthest from the transmitter 6 (upper right point of the touch surface 2). Accordingly, even when a reception level of a pen-synchronization pulse signal of the electronic pen 1 varies, it is possible to successfully detect the pen-synchronization pulse signal without fail regardless of the position of the electronic pen 1.

The pen-identification signal outputter 37 outputs a pen identification signal when it receives from the comparator 34 a signal indicating a detection of a pen-synchronization pulse signal. The pen identification signal is input into the receiving electrodes 4 from the pen point 33 after an output voltage level is adjusted by the output voltage adjustor 38.

The pen identification signal is configured with a pulse train of the predetermined bit number according to the number of the electronic pens 1 being used. For example, when the pen identification signal has a pulse train of 3 bit, it is possible to distinguish and use eight electronic pens 1 at a time. Accordingly, with pulse train of larger bit number in the pen identification signal, it is possible to identify a larger number of electronic pens 1.

A reception level of the pen identification signal received at the receiver 7 varies depending on touch positions of the electronic pens 1, similar to the reception level of the pen-synchronization pulse signal in the electronic pens 1. This is because impedance varies according to the length of the receiving electrodes 4 through which a signal passes after being transmitted from the electronic pen 1 and before being received by the receiver 7. In particular, when the touch screen system is used as an interactive whiteboard, the variety of reception level according to the touch position of the electronic pen 1 becomes more prominent or significant as the system becomes larger in size. To address the above circumstance, similar to the reception level of the pen synchronization pulse signal in the electronic pen 1, output voltage level of the output voltage adjustor 38 is adjusted by conducting a touch operation with the electronic pen 1 at a plurality of positions on the touch surface 2. This output voltage adjustment is conducted during an inspection process or the like before being shipped from a factory.

The LED lamp 39 lights up and notifies a user that the comparator 34 has detected a pen-synchronization pulse signal. Accordingly, the user can make sure that the electronic pens 1 are properly operating. Since the user can directly confirm the reception status of the pen-synchronization pulse signal in the electronic pens 1, the user can easily and properly set the threshold value by adjusting the threshold value with the operation switch 36 while checking the reception status of the pen-synchronization pulse signal with the LED lamp 39. Further, when the electronic pens 1 improperly touch the touch surface 2, the pen-synchronization pulse signal cannot be detected. In this case, the LED lamp 39 informs the user of an improper use of the electronic pens 1 and prompts a proper use.

The electronic pen 1 is provided with an operation switch 41 for the user to set a property (e.g., drawing color in a hand writing mode) thereof. Property information set by the operation switch 41 is sent to the controller 8, and consequently a display operation is performed with the property set by the user. In this embodiment, a pen identification signal, based on pen identification information that distinguishes the electronic pens 1, is transmitted in response to the pen-synchronization pulse signal. Herein, it is also possible to increase the bit number of a signal sent from the electronic pens 1 so as to send the property information set by the operation switch 41 along with the pen identification information.

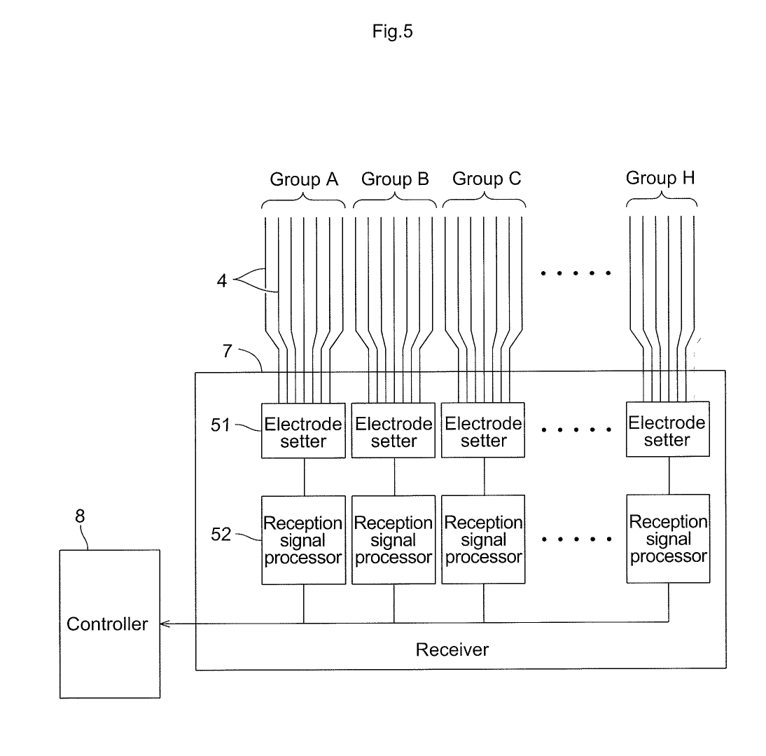

FIG. 5 is a schematic configuration diagram of the receiver 7. The receiving electrodes 4 are grouped every predetermined number of pieces. In this embodiment, 186 receiving electrodes 4 are grouped every 24 pieces into eight groups of A to H. The seven groups of A to G of the receiving electrodes 4 each include 24 pieces, and the last group H includes 18 pieces.

The receiver 7 includes an electrode selector 51 and a reception signal processor 52. In the electrode selector 51, a switching element is connected to each receiving electrode 4. While a pulse signal is being applied to one of the transmitting electrodes 3, the receiving electrodes 4 are selected one by one, and a response signal from the selected receiving electrode 4 is sequentially input into the reception signal processor 52. Thereby, the response signals can be retrieved from each of all the electrode intersections. Each switching element in the electrode selector 51 is individually switch-controlled according to a control signal from the controller 8.

The electrode selector 51 and the reception signal processor 52 are provided to each group of the receiving electrodes 4. In each electrode selector 51, mutually corresponding switching elements are turned on and off in parallel. In each group, the switching elements are turned on one by one while the remaining switching elements are turned off A response signal of one receiving electrode 4 selected by turning on the switching element is input to the reception signal processor 52.

Further, the pen-synchronization pulse signal, which is applied from the transmitter 6 to the transmitting electrodes 3, is transmitted to the receiving electrodes 4 through the electrode intersections. Subsequently, when the receiver 7 detects the pen-synchronization pulse signal output from the receiving electrodes 4, the receiver 7 enters a state to wait for the input of the pen identification signal.

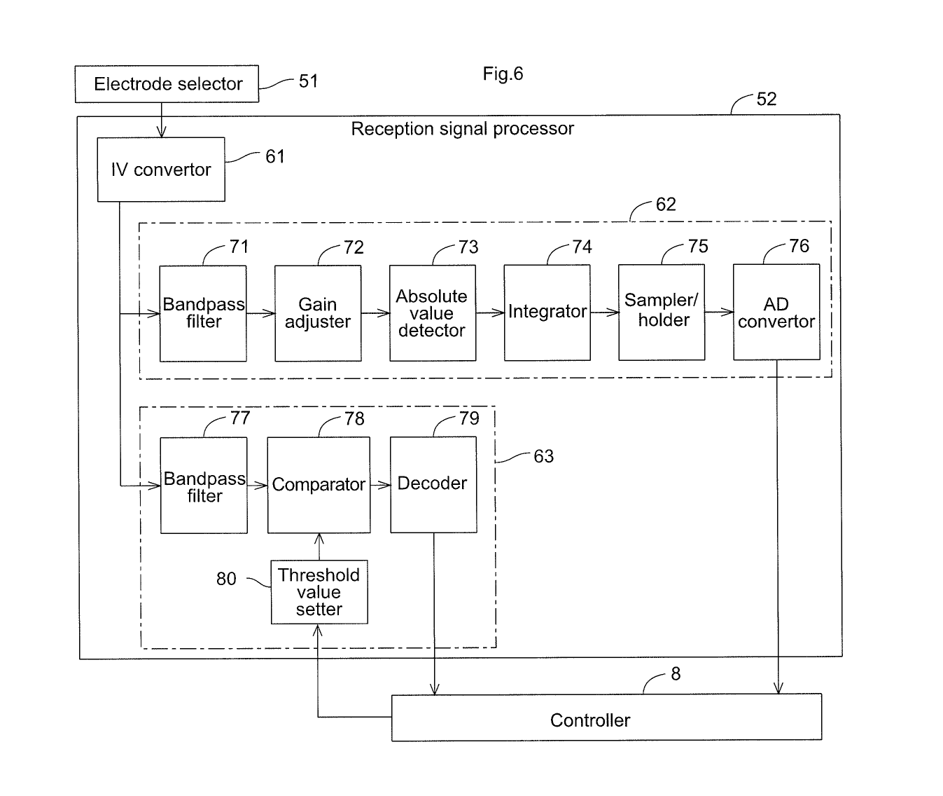

FIG. 6 is a schematic configuration view of the reception signal processor 52. The reception signal processor 52 includes an IV converter 61, a position-detection signal processor 62, and a pen-identification signal processor 63.

The IV converter 61 converts an output signal (analog current signal) being input to the IV converter 61 from the receiving electrodes 4 through the electrode selector 51, into a voltage signal. The position-detection signal processor 62 processes the voltage signal output from the IV converter 61 during the position-detection process period, in which a position-detection pulse signal is applied to the transmitting electrodes 3, and a response signal from the receiving electrodes 4 is received. The pen-identification signal processor 63 processes the voltage signal output from the IV converter 61 during the pen-identification process period, in which a pen-synchronization pulse signal is applied to the transmitting electrodes 3, and a pen identification signal from the electronic pens 1 is received.

The position-detection signal processor 62 includes a bandpass filter 71, a gain adjuster (amplifier) 72, an absolute value detector 73, an integrator 74, a sampler/holder 75, and an AD converter 76. The bandpass filter 71 removes from the output signal from the IV converter 61, a signal having a frequency component other than a frequency of a pulse signal applied to the transmitting electrodes 3. The gain adjuster 72 amplifies the output signal from the bandpass filter 71 at an amplification rate set by the controller 8. The absolute value detector (rectifier) 73 performs a full-wave rectification on the output signal from the gain adjuster 72. The integrator 74 integrates the output signal from the absolute value detector 73 in a time axis direction. The sampler/holder 75 samples the output signal from the integrator 74 at a predetermined timing. The AD converter 76 AD-converts the output signal from the sampler/holder 75 and outputs a detection data (digital signal).

The pen-identification signal processor 63 includes a bandpass filter 77, a comparator 78, a decoder 79, and a threshold value setter 80. Similar to the bandpass filter 71 of the position-detection signal processor 62, the bandpass filter 77 removes from the output signal from the IV converter 61, a signal having a predetermined frequency component. The comparator 78 converts an output signal from the bandpass filter 77 into a pulse train corresponding to a pen identification signal. The decoder 79 decodes the pulse train output from the comparator 78, and outputs a digital value of the pen identification signal.

The comparator 78 compares a voltage level of a signal input from the bandpass filter 77 with a threshold value input from the threshold value setter 80, and outputs a predetermined positive voltage when the voltage level of the input signal is higher than the threshold value. In this way, when a pen identification signal is received properly, the pulse train corresponding to the pen identification signal is output from the comparator 78. The threshold value stored in the threshold value setter 80 is set by the controller 8.

When a remaining charge amount of the battery 40 of the electronic pen 1 is not sufficient, a voltage of a pen identification signal transmitted from the electronic pen 1 decreases. When the voltage level of the pen identification signal input into the receiver 7 is lower than the threshold value of the comparator 78, the comparator 78 cannot output a normal pulse train corresponding to the pen identification signal. To address this circumstance, in an inspection mode or the like, a pen identification signal is transmitted from the electronic pen 1 by applying a pen-synchronization pulse signal to the transmitting electrodes 3. When the comparator 78 does not output a normal pulse train, the controller 8 determines that there is not a sufficient amount of charge remaining in the battery of the electronic pen 1. Accordingly, the controller 8 causes the external apparatus 9 to display a warning in order to inform a user that the battery 40 needs to be replaced or charged.

The process to determine the remaining battery charge amount is performed by touching a plurality of positions on the touch surface with the electronic pen 1, similar to the adjustment of the threshold value with the operation switch 36 of the electronic pen 1. The reception level of the pen identification signal received by the receiver 7 varies depending on touch positions of the electronic pen 1. As describe earlier, this is due to the variation of impedance according to the length of the receiving electrodes 4, through which the pen identification signal passes. To address this circumstance, the process to determine the remaining battery charge amount is performed at a plurality of locations on the touch surface, for example, two locations: one is the position closest to the receiver 7 (e.g., a lower left point of the touch surface) and the other is the position farthest from the receiver 7 (e.g., an upper right point of the touch surface). Thereby, it is possible to accurately determine the remaining battery charge amount even when a reception level of a pen identification signal in the receiver 7 varies depending on positions of the electronic pen 1.

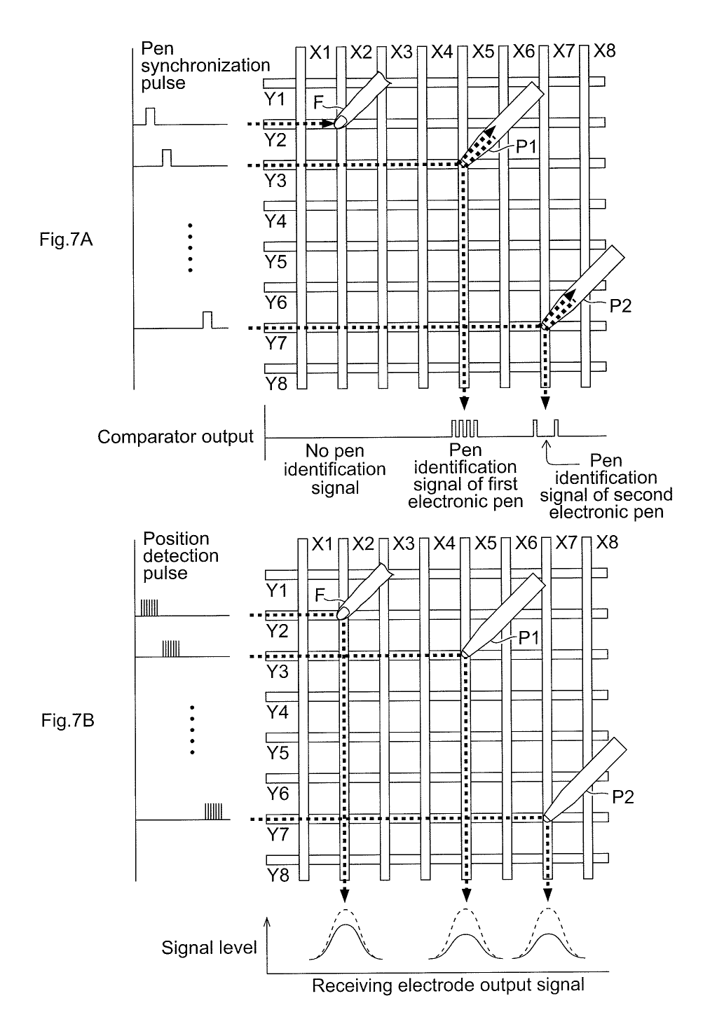

FIG. 7A illustrates a process of a pen identification to identify the electronic pens 1. FIG. 7B illustrates a process of a position detection to detect a touch position. Herein, a finger F and two electronic pens P1 and P2 are used as pointing objects for a touch operation. Also, the transmitting electrodes 3 and the receiving electrodes 4 are denoted as Y1 to Y8 and X1 to X8, respectively.

As shown in FIG. 7A, in the pen identification process, pen-synchronization pulse signals are sequentially applied to the transmitting electrodes Y1 to Y8. The first and second electronic pens P1 and P2 each transmit a pen identification signal in synchronization with the pen-synchronization pulse signals. The pen-synchronization pulse signals are transmitted from the transmitting electrodes Y1 to Y8 to the receiving electrodes X1 to X8. The switching element of the electrode selector 51 of the receiver 8 is turned on in response to the pen-synchronization pulse signals output from the receiving electrodes X1 to X8. Accordingly, the pen identification signals of the electronic pens P1 and P2 are each input into the reception signal processor 52. The comparator 78 of the reception signal processor 52 outputs a pulse train corresponding to the pen identification signals. Based on the pulse train, the pointing object determiner 12 of the controller 8 identifies the electronic pens P1 and P2 that perform a touch operation. Further, in a touch operation with the finger F, no pen identification signal is received, therefore it is possible to determine that the touch operation is performed by the finger F.

As shown in FIG. 7B, in the position detection process, position-detection pulse signals are sequentially applied to the transmitting electrodes Y1 to Y8. The receiving electrodes X1 to X8 output a response signal in response to the pulse signals. When the finger F or the electronic pen P1 or P2 perform a touch operation, capacitance changes at an electrode intersection in the proximity of the touch position. Accordingly, the level of the response signal output from the receiving electrodes X1 to X8 drops. Therefore, the touch position calculator 11 of the controller 8 detects the touch position. At this time, detection data are provided at each electrode intersection, thus, even when touch operations are simultaneously performed with the plurality of pointing objects, such as the electronic pens P1 and P2 and the finger F, touch positions can be detected for each pointing object.

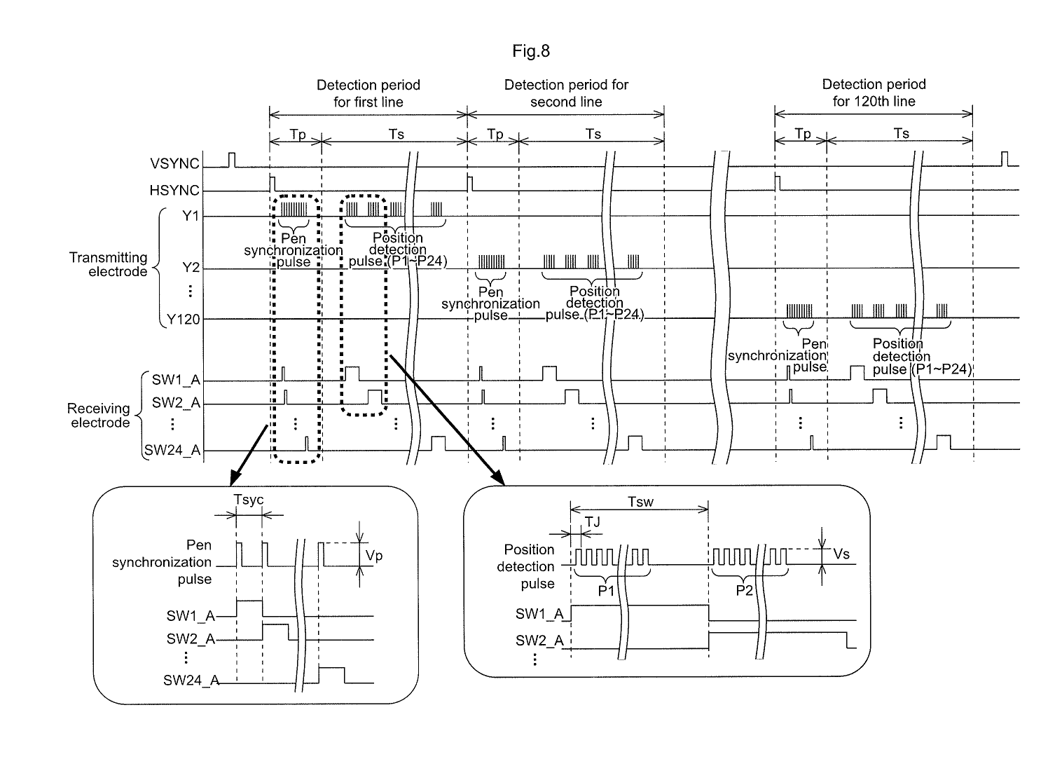

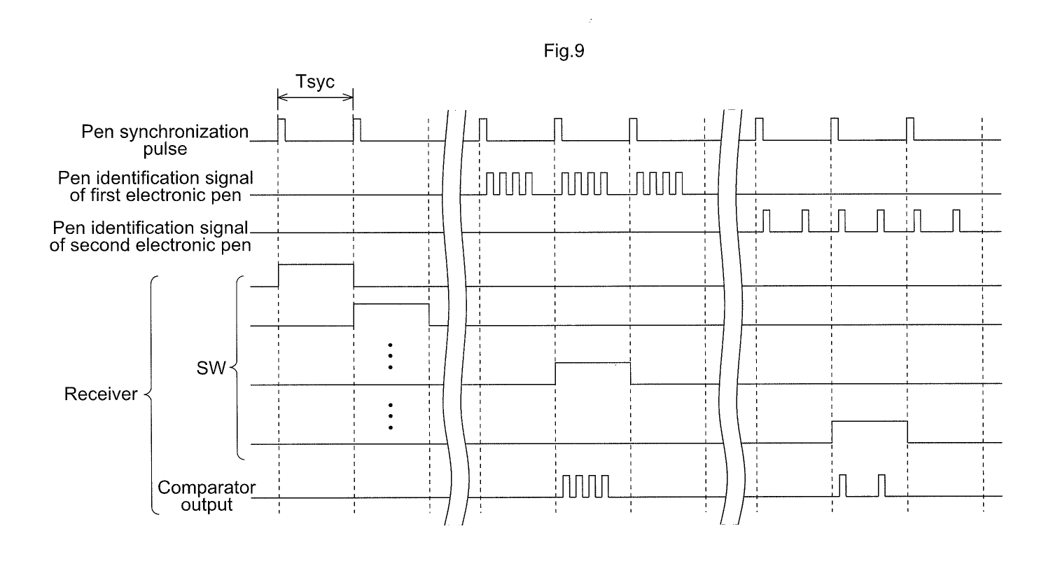

FIG. 8 illustrates a state of position-detection pulse signals and pen-synchronization pulse signals applied to the transmitting electrodes 3, and an operating state of switching elements SW provided to each receiving electrode 4. FIG. 9 illustrates a state of transmitting a pen identification signal in the electronic pen 1, and a state of output from a comparator of the receiver 7.

In FIG. 8, 120 transmitting electrodes 3 are denoted as Y1, Y2 . . . , and Y120 from a first end. The switching elements of the receiving electrodes 4 included in the group A are denoted as SW1_A, SW2_A . . . , SW24_A. Although only the operation of the switching elements of the receiving electrodes 4 included in the group A is shown here, the operations are performed in the same manner in the groups B to H. Herein, the mutually corresponding switching elements in the groups A to H are simultaneously and concurrently turned on and off.

As shown in FIG. 8, firstly, a vertical synchronization signal (VSYNC), defining a start time of one frame, is output from the controller 8 to the transmitter 6. Then, a horizontal synchronization signal (HSYNC), defining a time for applying a pen-synchronization pulse signal and a position detection pulse signal to each transmitting electrode 3, is output from the controller 8 to the transmitter 6. The transmitter 6 outputs a pen-synchronization pulse signal by selecting a transmitting electrode 3 in accordance with the horizontal synchronization signal (HSYNC). At this time, a pulse is output 24 times, which corresponds to the number of receiving electrodes 4 included in one group, with an interval Tsyc. Further, a voltage level Vp of the pen-synchronization pulse signal is higher than a voltage level Vs of the position-detection pulse signal (Vp≧Vs).

As shown in FIG. 9, the electronic pen 1 transmits a pen identification signal every time it detects a pen-synchronization pulse signal. While a transmitting electrode 3 that is in proximity of a touch position of the electronic pen 1 is selected, the electronic pen 1 continuously detects the pen-synchronization pulse signal, therefore the pen identification signal is repeatedly output.

The receiver 7 sequentially selects each receiving electrode 4 every time it detects a pen-synchronization pulse signal, and receives pen identification signals from each of the receiving electrodes 4 one by one. In other words, the switching elements SW of the electrode selector 51 are sequentially turned on one by one in response to the pen-synchronization pulse signal. Specifically, the switching element SW is tuned on at a leading pulse, and is tuned off at the next leading pulse. Each switching element SW is turned on with a period corresponding to the pulse interval Tsyc.

Accordingly, the electrode selector 51 inputs a pen identification signal into the reception signal processor 52 at the time when the receiving electrode 4 close to a touch position of the electronic pen 1 is selected. Subsequently, the comparator 78 of the reception signal processor 52 outputs a pulse train corresponding to the pen identification signal. Further, when the transmitting electrode 3 close to a touch position of the electronic pen 1 is not selected, the electronic pen 1 cannot detect a pen-synchronization pulse signal, thus the electronic pen 1 does not transmit a pen identification signal. As described later, however, while transmitting electrodes 3 are sequentially switched, the transmitting electrode 3 close to the touch position of the electronic pen 1 is selected. Accordingly, the electronic pen 1 detects a pen-synchronization pulse signal and transmits a pen identification signal.

As shown in FIG. 8, the transmitter 6 outputs a position-detection pulse signal to the same transmitting electrodes 3 at a predetermined timing based on the horizontal synchronization signal (HSYNC). In this embodiment, pulse trains corresponding to one receiving electrode 4 are repeatedly output 24 times, which corresponds to the number of receiving electrodes 4 included in one group, with a predetermined interval. For each of the pulse trains (P1 to P24) corresponding to one receiving electrode 4, a predetermined number of pulses (e.g., 10) is output with an interval Tj based on the value set by the frequency setter 22.

The receiver 7 sequentially turns on the switching elements SW1_A to SW24_A of the electrode selector 51 at a predetermined timing based on the horizontal synchronization signal (HSYNC) with an interval Tsw, in which each pulse train (P1 to P24) corresponding to each receiving electrode 4 is transmitted, and receives a response signal output from the receiving electrode 4.

In this way, in accordance with each horizontal synchronization signal (HSYNC), one line corresponding to each transmitting electrode 3 is processed. The processing on one line is repeatedly performed on all 120 transmitting electrodes 3 based on the horizontal synchronization signal (HSYNC). Thus, the detection data for each electrode intersection included in one frame and the pen identification data for the electronic pen 1 being used for a touch operation are obtained.

In this embodiment, a pen-identification process period Tp and a position-detection process period Ts are provided not to overlap with each other. In the pen-identification process period Tp, a pen-synchronization pulse signal is applied to the transmitting electrodes 3 so that a pen identification signal of the electronic pen 1 is received through the receiving electrodes 4; and in the position-detection process period Ts, a position-detection pulse signal is applied to the transmitting electrodes 3 so that a reception signal is received from the receiving electrodes 4. In particular, the pen-identification process period Tp is provided before the position-detection process period Ts, thus the pen identification signal of the electronic pen 1 can be obtained at an earlier timing. Thereby, it is possible to further successfully prevent a phenomenon that the electronic pens 1 are mistakenly recognized as a finger.

Contrary to the shown example, the pen-identification process period Tp may be provided after the position-detection process period Ts.

In a pen identification process, only one pulse per receiving electrode 4 needs to be applied to the transmitting electrodes 3, thus the number of applied pulses is smaller compared with that in the position detection process. Further, the pen identification signal does not require a large bit number, thus the switching element of the receiver 7 needs to be in the ON state only for a short period of time. Accordingly, the pen-identification process period Tp is shorter than the position-detection process period Ts. Specifically, a pulse interval in the pen-identification process period Tp, that is, a period (Tsyc) when the switching element is in the ON state, is 300 n sec, for example. An interval for transmitting a pulse train in the position-detection process period Ts, that is, a period (Tsw) when the switching element is in the ON state, is 3.4 μ sec, for example. Thus, the pen-identification process period Tp is one-fifth to one-tenth of the position-detection process period Ts. Therefore, time required to process one frame is not increased by a great amount, thereby making it possible to prevent a speed for touch position detection from being decreased.

In this embodiment, the pen identification process, along with the position detection process, is performed on each one of the transmitting electrodes 3. Thus, a Y-direction (arrangement direction of the transmitting electrodes 3) position of the electronic pen 1, which is the original sender of the pen identification signal, can be estimated based on which transmitting electrode 3 is being supplied with a pen-synchronization pulse signal when the pen identification signal is received.

The transmitter 6 applies a pen synchronization pulse signal a plurality of times (24 times, in this embodiment), which corresponds to the number of the receiving electrodes 4 (24, in this embodiment). The electronic pen 1 transmits a pen identification signal at each detection of a pen-synchronization pulse signal. The receiver 7 switches the receiving electrodes 4 at each detection of a pen-synchronization pulse signal, and receives the pen identification signal from each one of the receiving electrodes 4. Thus, an X-direction (arrangement direction of receiving electrodes 4) position of the electronic pen 1, which is the original sender of the pen identification signal, can be estimated based on which receiving electrode 4 has received the pen identification signal.

As described above, the controller 8 can locate an approximate position of the electronic pen 1 that has originally transmitted a pen identification signal based on the receiving electrode 4 that receives a pen identification signal and the transmitting electrode 3 identified from the timing of receiving the pen identification signal. By comparing the approximate position with the detection result of a touch position, it is possible to determine which electronic pen 1 has provided the detected touch position. Further, when no pen identification signal corresponding to the touch position is obtained, it is determined that the touch position is provided by a user's finger.

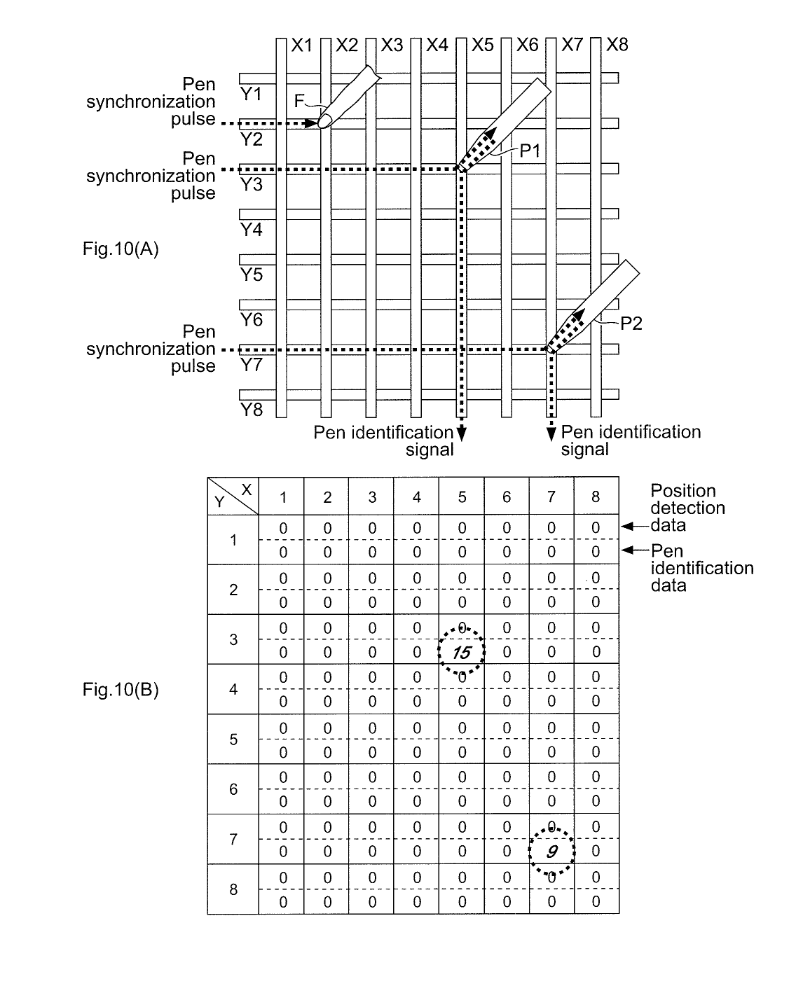

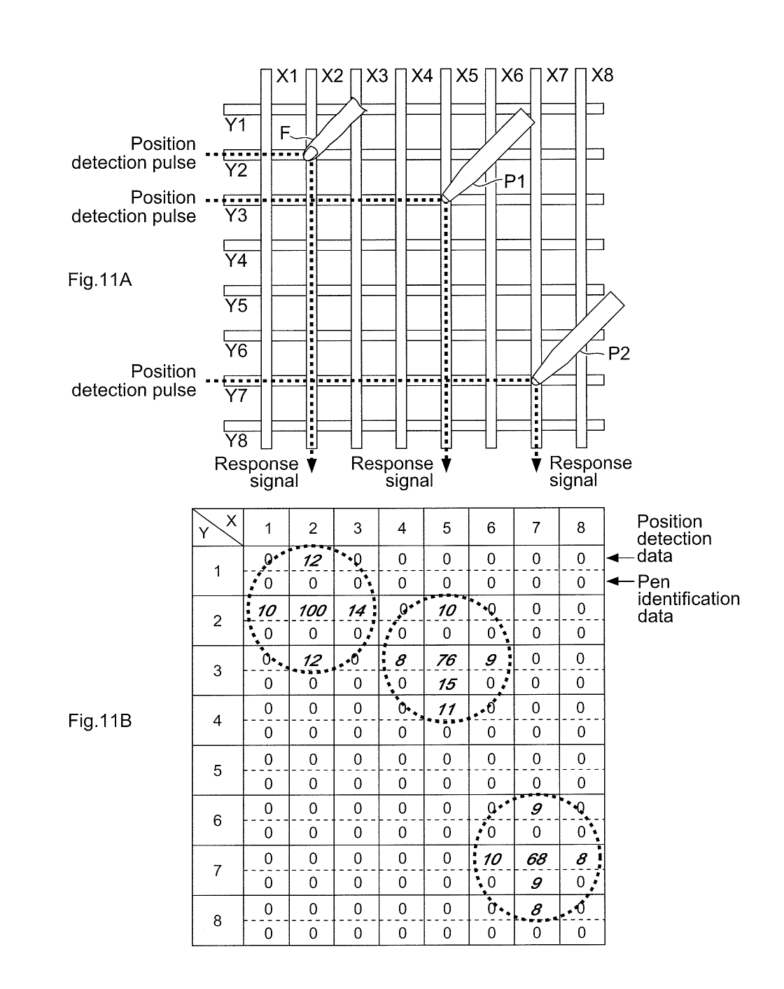

FIGS. 10A and 10B illustrate a process of the pen identification to identify the electronic pens 1, and a state of pen detection data stored in a memory of the controller 8. FIG. 11A and 11B illustrate a process of the position detection to detect a touch position, and a state of position detection data stored in the memory in the controller 8. In FIGS. 10A and 11A, the transmitting electrodes 3 are denoted as Y1 to Y8, and the receiving electrodes 4 are denoted as X1 to X8. In FIGS. 10B and 11B, the respective position detection data are shown on upper portions of each field and the pen identification data are shown in lower portions of each field corresponding to the electrode intersections of the transmitting electrodes Y1 to Y8 and the receiving electrodes X1 to X8.

In the shown example, the finger F touches the position of the electrode intersection (2, 2) where the receiving electrode X2 intersects with the transmitting electrode Y2; the first electronic pen P1 touches the position of the electrode intersection (5, 3) where the receiving electrode X5 intersects with the transmitting electrode Y3; the second electronic pen P2 touches the position of the electrode intersection (7, 7) where the receiving electrode X7 intersects with the transmitting electrode Y7.

As shown in FIGS. 10A and 10B, in the pen identification process, pen identification signals transmitted from the electronic pens P1 and P2 are output from the receiving electrodes X1 to X8. Subsequently, the receiver 7 outputs pen identification data. The controller 8 determines the electrode intersections that are closest to the electronic pens P1 and P2 based on the receiving electrodes X1 to X8 that receive the pen identification signal, and the transmitting electrodes Y1 to Y8 identified by a timing of receiving the pen identification signal. The pen identification data is stored in the memory at an address, which corresponds to the determined electrode intersection.

As shown in FIGS. 11A and 11B, in the position detection process, the receiving electrodes X1 to X8 output response signals in response to position-detection pulse signals applied to the transmitting electrodes Y1 to Y8. Subsequently, the receiver 7 outputs position detection data. The controller 8 calculates a differential data between a non-touch state and a touch state. The differential data is stored in the memory at an address corresponding to each electrode intersection, and a touch position is calculated therefrom. When capacitance changes in conjunction with touch operations at a plurality of electrode intersections, the differential data are also stored in the plurality of addresses.

As described above, the position detection data and the pen identification data for each electrode intersection are stored in the memory at the address corresponding to each electrode intersection. It is possible to identify which of the electronic pens P1 and P2 provides a touch based on the position detection data and the pen identification data. In the case of a touch operation performed with the finger F, no pen identification data exists at the address where the position detection data exists, thereby making it possible to determine that a touch position is provided by the finger F.

Even when a plurality of pointing objects, such as the electronic pens P1 and P2 and the finger F, are used for touch operations, it is possible to successfully determine which pointing object has provided a touch position by associating touch position data and pen identification data per an electrode intersection. In this way, a display operation is performed with properties specified by a user. For instance, in a hand-writing mode, lines are drawn with properties set for each electronic pen P1 or P2, or a finger F.

When a touch position is provided by the electronic pens P1 and P2 in the middle of two neighboring ones of the transmitting electrodes Y1 to Y8 and two neighboring ones of the receiving electrodes X1 to X8, a plurality of electrode intersections having the pen identification data appear side by side. However, when the transmitting electrodes Y1 to Y8 and the receiving electrodes X1 to X8 are arranged at a pitch of 1 cm, for example, it is extremely rare that the touch positions of the plurality of electronic pens P1 and P2 are located at the same electrode intersection. Thereby, it is possible to identify the electronic pens P1 and P2 from each other with sufficient accuracy.

The touch screen system according to the present invention is capable of simultaneously performing touch operations with a plurality of pointing objects, such as electronic pens and a finger, while successfully identifying the pointing objects from one another. Further, in the touch screen system according to the present invention, an unlimited number of electronic pens can be employed, thereby providing improved convenience in use. Furthermore, the touch screen system according to the present invention enables a touch operation with both an electronic pen and a finger.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen system, comprising:
a plurality of electronic pens;
a panel main body comprising a touch surface, on which a touch operation is performed with the electronic pens, a plurality of transmitting electrodes extending in parallel to one another, and a plurality of receiving electrodes extending in parallel to one another, the transmitting and receiving electrodes being arranged in a grid pattern, to provide a plurality of electrode intersections between the plurality of transmitting electrodes and the plurality of receiving electrodes;
a transmitter that applies a driving signal to the transmitting electrodes;
a receiver that receives a response signal output from the receiving electrodes that have responded to the driving signal applied to the transmitting electrodes, and outputs detection data of each electrode intersection; and
a controller that detects a touch position based on the detection data output from the receiver,
wherein each of the plurality of electronic pens transmits a pen identification signal including pen identification information to the receiving electrodes at the time of the touch operation; and
the controller determines an electronic pen that performs the touch operation based on the pen identification signal received by the receiver through the receiving electrodes.

2. The touch screen device according to claim 1, wherein the controller determines that a touch operation is performed with a finger when no pen identification signal corresponding to the touch position is received.

3. The touch screen device according to claim 1, wherein the pen identification signal is a pulse train of a predetermined bit number.

4. The touch screen device according to claim 1, wherein the transmitter applies a pen synchronization signal to the transmitting electrodes; and the electronic pens transmit the pen identification signal to the receiving electrodes in accordance with detection of the pen synchronization signal of the transmitting electrodes at the time of the touch operation.

5. The touch screen system according to claim 4, wherein a position detection process and a pen identification process are performed on each one of the transmitting electrodes, the position detection process applying the driving signal to the transmitting electrodes so that a response signal from one of the receiving electrodes is received, and the pen identification signal applying the pen synchronization signal to the transmitting electrodes so that the pen identification signal from one of the electronic pens is received through the receiving electrodes.

6. The touch screen system according to claim 5, wherein the pen identification process is performed before the position detection process.

7. The touch screen system according to claim 4, wherein the transmitter applies the pen synchronization signal a plurality of times, which corresponds to the number of the receiving electrodes,
the electronic pens transmit the pen identification signal at every detection of a pen synchronization signal, and
the receiver switches the receiving electrodes at every detection of a pen synchronization signal, and receives the pen identification signal from each of the receiving electrodes.

8. The touch screen system according to claim 4, wherein each of the electronic pens comprises:
a pen synchronization signal detector that compares a voltage level of a signal input from the transmitting electrodes with a threshold value, and determines whether or not the signal is the pen synchronization signal

9. The touch screen system according to claim 8, wherein each of the electronic pens further comprises an operator that changes the threshold value.

10. The touch screen system according to claim 4, wherein the transmitter applies the pen synchronization signal with a voltage level different from a voltage level of the driving signal, to the transmitting electrodes.

11. The touch screen system according to claim 4, wherein each of the electronic pens comprises a display that notifies a user that the pen synchronization signal has been detected.

12. The touch screen system according to claim 1, wherein each of the electronic pens comprises an output voltage adjustor that adjusts an outputs voltage level of the pen identification signal.

13. The touch screen system according to claim 1, wherein each of the electronic pens comprises an operation switch that sets a property of the electronic pen.

14. The touch screen system according to claim 1, wherein the controller determines a remaining charge amount of a battery provided to the electronic pens based on a reception voltage level of the pen identification signal at the receiver.

15. The touch screen system according to claim 1, wherein the transmitter includes a position detection pulse generator, a pen-synchronization pulse generator and an electrode selector.

16. The touch screen system according to claim 15, wherein the position detection pulse generator and the pen-synchronization pulse generator each generate a pulse train at a timing based upon a synchronization signal output from the controller.

17. The touch screen system according to claim 15, wherein the position detection pulse generator and the pen-synchronization pulse generator each output signals that are transmitted to the transmitting electrodes by time sharing.

18. The touch screen system according to claim 9, wherein the adjustment of the threshold value comprises conducting a touch operation with the electronic pen at a predetermined position of the touch panel.

19. The touch screen system according to claim 18, wherein the predetermined position comprises a plurality of positions including a position close to the transmitter and a position far from the transmitter.

20. The touch screen system according to claim 14, wherein determining the remaining charge amount of the battery comprises performing a touch operation with the electronic pen at a plurality of locations on the touch surface.
